(19) United States
(12) Patent Application Publication
(10) Pub. No.: US 2025/0075999 A1
(43) Pub. Date: Mar. 6, 2025

(54) CARBON FIBER GUN STOCK AND METHODS OF FABRICATION

(71) Applicant: Gunwerks LLC, Cody, WY (US)

(72) Inventors: Aaron DAVIDSON, Cody, WY (US); Josh MOORE, Cody, WY (US); Jim ALLAN, Cody, WY (US)

(21) Appl. No.: 18/817,603

(22) Filed: Aug. 28, 2024

Related U.S. Application Data
(60) Provisional application No. 63/579,318, filed on Aug. 29, 2023.

(51) Int. Cl. F41C 23/18; B29C 43/00; B29C 43/12; B29C 43/18; B29C 43/20; B29K 63/00; B29K 105/12; B29K 307/04; B29L 31/00

(52) U.S. Cl. CPC F41C 23/18; B29C 43/003; B29C 43/12; B29C 43/18; B29C 43/203; B29C 2043/182; B29C 2793/0027; B29C 2793/009; B29K 2063/00; B29K 2105/12; B29K 2307/04; B29K 2995/0077; B29L 2031/777

(57) ABSTRACT

In one embodiment, a stock assembly is provided. The stock assembly includes a shell having a front region, a grip region, a rear region, a frame cavity partially defined by the shell, and one or more stiffener cavities disposed within the shell. One or more stiffeners are disposed within the one or more stiffener cavities. The stiffeners include a core material and the core material is bonded to an internal surface of the one or more stiffener cavities.

### CROSS-REFERENCE TO RELATED APPLICATIONS

This application claims benefit of U.S. Provisional Patent Application No. 63/579,318, filed Aug. 29, 2023, the entirety of which is herein incorporated by reference.

### BACKGROUND

### Field

Embodiments of the present disclosure generally relate to a stock for a firearm.

### Description of the Related Art

A stock is a common part for many firearms, but is often a significant portion of the entire weight of the firearm. It is desirable for a stock to be strong, durable, and properly made to ensure the firearm functions properly. Stock design is often a compromise between strength and weight with an inverse relationship between the strength and weight variables. Generally, when material is removed from the stock, making it lighter, the stock becomes weaker and subject to failure. A stock that exhibits high strength and durability may be too heavy and render the firearm unfit for its intended application or transport during shooting or hunting activities. Thus, there is a need for an improved stock for a firearm.

### SUMMARY

In one embodiment, a stock assembly is provided. The stock assembly includes a shell having a front region, a grip region, a rear region, a frame cavity partially defined by the shell, and one or more stiffener cavities disposed within the shell. One or more stiffeners are disposed within the one or more stiffener cavities. The stiffeners include a core material and the core material is bonded to an internal surface of the one or more stiffener cavities.

In another embodiment, a stock stiffener is provided. The stock stiffener includes a muzzle end and a grip end, a plurality of tapers, and a core material. The core material includes a first resin, a second resin, a first material, and a fiber material.

In another embodiment, a process of forming a stock is provided. The process includes disposing a first layer of a shell material in a mold, disposing one or more stiffeners within the mold, disposing a second layer of the shell material over the one or more stiffeners and the first layer, co-curing the first layer, the one or more stiffeners, and the second layer to form a bond between the one or more stiffeners and the shell material, and forming a shell.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments of the disclosure and are therefore not to be considered limiting of its scope, as the disclosure admit to other equally effective embodiments.

FIG. 1 is a schematic side view of a stock according to one or more embodiments.

FIG. 2 is a schematic top view of a stock according to one or more embodiments.

FIG. 3 is a schematic side view of a stiffener according to one or more embodiments.

FIG. 4 is a cross-sectional view of the stock of FIG. 1 taken along line A-A according to one or more embodiments.

FIG. 5 is a cross-sectional view of the stock of FIG. 1 taken along line B-B according to one or more embodiments.

FIG. 6 is a cross-sectional view of the stock of FIG. 1 taken along line C-C, according to one or more embodiments.

FIG. 7 illustrates a process of forming a stock assembly according to one or more embodiments.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

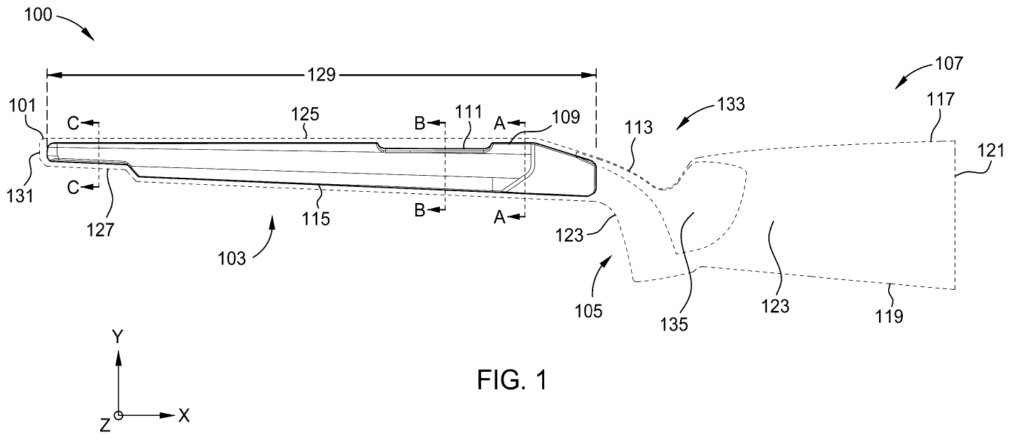

FIG. 1 illustrates a schematic side view of a stock assembly 100 according to one or more embodiments. In some embodiments, the stock assembly 100 is mirrored such that each side of the stock assembly 100 is the same as or substantially similar to the other side. In other embodiments, the stock assembly 100 includes a bolt notch on one side which is not mirrored on the opposing side. The stock assembly 100 includes a shell 101 and one or more stiffeners 109. The one or more stiffeners 109 may be stock stiffeners configured to add one or more of strength, durability, and rigidity to a firearm stock. In some embodiments, the one or more stiffeners 109 are a first stiffener 109A and a second stiffener 109B that mirror one another. In other embodiments, there is a single stiffener 109. The shell 101 includes lateral faces 123, a front region 103, a grip region 105, and a rear region 107. The shell 101 may include one or more weave styles. Weave styles include carbon fiber and fiberglass materials combined with an epoxy material to form various weaves, including but not limited to, a 3k twill weave, 3k plain weave, 1k plain weave, unidirectional weave, or 8 harness satin weave. The shell 101 may also include a sheet molding compound. The shell 101 may be made up of a material including a composite, a polymer, a monomer, or any combination thereof. For example, the material of the shell 101 includes carbon fiber. In yet another example, the material of the shell 101 includes a carbon fiber formed using an epoxy resin. In yet another example, the material of the shell 101 includes a carbon fiber formed using a shell resin comprising an epoxy matrix formed by two or more epoxy resins. In various examples, the epoxy matrix includes a resin and a hardener. The lateral faces 123 are the exterior faces of the shell 101. The lateral faces 123 are disposed in the positive and negative Z direction.

The front region 103 includes a muzzle end 131, a forend 115, an ejection port 111, and an accessory region 127. The forend 115 is a flat base that provides a stable surface when operating a firearm. In one example, an operator of a firearm having the stock assembly 100 grips the forend 115 to facilitate carrying or aiming of the firearm. The forend 115 extends from the grip region 105 to the accessory region 127. In some embodiments, the forend 115 includes mounting features. The mounting features include any device that could be mounted to the stock of a firearm. The mounting features include slings, bi-pods, grommets, quick detach (QD) inserts and/or receivers, and/or any combination thereof. For example, a mounting feature could be an M-LOK® rail or other rail interface system. The accessory region 127 is disposed between the muzzle end 131 of the shell 101 and the forend 115. The accessory region 127 extends a lesser magnitude than the magnitude of extension of the forend 115. The accessory region 127 enables the stock assembly 100 to incorporate mounting features. The mounting features include those mentioned above or other suitable mounted accessories. For example, the mounting feature may be a picatinny rail. The forend 115 also includes a bottom metal port (not shown) that enables a chassis, trigger group, magazine port, and/or other internal structure to sit within the stock assembly 100. The bottom metal port enables a trigger guard and trigger to be coupled to the stock assembly 100. The bottom metal port enables the firearm to be fed by a magazine. In some embodiments, the bottom metal port enables a hinged floorplate style bottom metal feature.

The forend 115 is disposed opposite a top 125 of the stock assembly 100. The top 125 includes the ejection port 111. In one embodiment, the top 125 extends from the ejection port 111 to the muzzle end 131 of the stock assembly 100. The ejection port 111 is configured to enable a cartridge to be ejected from the firearm. In some embodiments, the ejection port 111 is configured to enable rifle actions to eject a cartridge at lower exit angles so that a cartridge does not hit an optic mounted on the firearm above the top 125. The ejection port 111 has a width along the top 125 between about 2 inches″ and about 5 inches. For example, the ejection port 111 has a width of about 3.5 inches.

The grip region 105 is disposed between the front region 103 and the rear region 107. The grip region 105 includes a thumb shelf 113, a grip 133, and a portion of the stiffener 109. The thumb shelf 113 is at least partially disposed in an overlapping relationship with the stiffener 109. Similarly, the stiffener 109 is at least partially disposed in an overlapping relationship with the thumb shelf 113. The thumb shelf 113 is disposed along the top 125 of the shell 101. The stiffener 109 is disposed within the shell 101 partially beneath the thumb shelf 113 and separated by the top 125 layer of the shell 101. This configuration enables the stiffeners 109 to provide rigidity to the shell 101 at specific regions where improved strength or rigidity are desirable which enables enhanced weight savings when compared to stocks with stiffeners extending along the entirety of the stock.

The grip 133 is disposed adjacent to the thumb shelf 113 and the stiffener 109. In some embodiments, the grip 133 is disposed beneath the thumb shelf 113, such that a user's thumb is able to rest on the thumb shelf 113 when the grip 133 receives a user's hand thereon. In some embodiments, the grip 133 is hollow or partially hollow. As discussed in greater detail hereinafter, a hollow region of the stock assembly 100 begins at the end of the stiffeners 109 opposite the muzzle end 131.

The rear region 107 is coupled to the grip region 105 opposite the front region 103. The rear region 107 includes a lateral face 123, a comb 117, a toe 119, a butt 121, and a palm region 135. The comb 117 is the top surface of the rear region 107 of the stock assembly 100. The comb 117 is a negative comb, decreasing in height along the top 125 from the butt 121 to the grip region 105. The comb 117 reduces felt recoil upon firearm discharge and enables a higher recoil pad positioning on the butt 121. The comb 117 enables a recoil pad to be disposed in line with a barrel, which enables reduced muzzle rise upon discharge of the firearm. The toe 119 is a flat surface on the bottom of the rear region 107 of the stock assembly 100. The toe 119 enables greater ease of adjustment during operation because a shooting bag, monopod, or other stabilization apparatus can interface with a surface of the toe 119. The toe 119 is flat or substantially flat in the X-Z plane and angles up, in the positive Y direction from the butt 121 to the grip region 105. The palm region 135 is configured to receive the palm of a user's hand when the hand interacts with the stock assembly 100. The lateral face 123 extends from the comb 117 to the toe 119 in the X-Y plane. The palm region 135 is a depression in the shell 101 that enables the user's thumb to rest on the thumb shelf 113 when holding a firearm. The lateral face 123 extends from the butt 121 to the palm region 135 in the X-Y plane. The palm region 135 provides improved ergonomics to the stock assembly 100 which may improve a user's shooting experience and accuracy.

The stiffener 109, which is disposed within the shell 101, includes a length 129 and a core material. The stiffener 109 is partially disposed in the front region 103 of the stock assembly 100 and extends partially into the grip region 105. The stiffener 109 can be one stiffener 109 or more than one stiffener 109. For example, the stock assembly 100 includes two stiffeners 109. In some embodiments, the stock assembly 100 includes three or more stiffeners 109. The length 129 of the stiffener 109 along the X-axis is between about 14 inches and about 22 inches. For example, the length 129 of the stiffener 109 is about 18 inches. In some embodiments, a single stiffener 109 weighs between about 200 g and about 275 g. For example, the single stiffener 109 weighs about 207.5 g. In yet another example, the single stiffener 109 weighs about 245 g. In yet another example, the single stiffener 109 weighs about 265 g.

The core material of the stiffener 109 may be fabricated from a composite material, a polymer material, a monomer material, a foam material, a syntactic foam material, or any combination thereof. The core material may include a first resin, a second resin, a density adjustment material, and a fiber material. The core material has a density between about 0.9 g/cc and about 0.6 g/cc. For example, the core material has a density of about 0.75 g/cc. In some embodiments, the core material includes polyurethane expanding foam, syntactic epoxy, thermoplastic expanding microspheres, or any combination thereof.

When placed into a 3 point bend test, a stiffener of the core material has a break load, depending on a cross sectional area, perpendicular to the major longitudinal axis. The break load is between about 107 pounds and about 278 pounds. For example, when a stiffener has a cross sectional area of between about 0.6 square inches and about 0.7 square inches, the break load is between about 210 pounds and about 278 pounds, for example 235 pounds. For example, when a stiffener has a cross sectional area of between about 0.4 square inches and about 0.5 square inches, the break load is between about 105 pounds and about 121 pounds, for example 115 pounds.

When placed into a 3 point bend test, a stiffener of the core material has a failure stress between about 225 psi and about 450 psi, for example, a failure stress of about 315 psi, depending on the cross sectional area. For example, when a stiffener has a cross sectional area of between about 0.6 square inches and about 0.7 square inches, the failure stress is between about 320 psi and about 440 psi, for example, a failure stress of about 365 psi. For example, when a stiffener has a cross sectional area of between about 0.4 square inches and about 0.5 square inches, the failure stress is between about 240 psi and about 275 psi, for example, a failure stress of about 260 psi.

The proportions of the first resin, the second resin, the density adjustment material, and the fiber material may be adjusted to achieve a desired strength to weight ratio. The core material includes weight percentages of the first resin, the second resin, the density adjustment material, and the fiber material. In some embodiments, the first resin is between about 57% and about 63% of the weight of the stiffener 109. For example, the first resin is about 61% of the weight of the stiffener 109. In some embodiments, the second resin is between about 12% and about 17% of the weight of the stiffener 109. For example, the second resin is about 15% of the weight of the stiffener 109. In some embodiments, the density adjustment material is between about 10% and about 14% of the weight of the stiffener 109. For example, the density adjustment material is about 12% of the weight of the stiffener 109. In some embodiments, the fiber material is between about 9% and about 12% of the weight of the stiffener 109. For example, the fiber material is about 11% of the weight of the stiffener 109. The core material includes a weight ratio of the first resin, the second resin, the density adjustment material, and the fiber material. For example, the weight ratio of the core material is between about 6.2:1.6:1.25:1.1 and about 6:1.5:1.15:1, for example, about 6.1:15.2:1.2:1.09.

The first and second resin may be an epoxy matrix resin and hardener, respectively. For example, the first resin and the second resin are epoxy resins. In yet another example, the first resin is a resin and the second resin is a hardener. In some embodiments, the first and second resin may be a polyurethane resin. The first and second resin may be configured to interact with the shell material such that the shell material and core material are bonded and form a bond when co-cured. In other words, an epoxy matrix resin of the shell material may be configured to bond with the core material of the stiffener 109. The first and second resin may be configured to interact with the shell material such that the shell 101 and the one or more stiffeners 109 are bonded when co-cured.

The fiber material may be any fibrous material. For example, the fiber material includes carbon fiber, fiberglass, metal fibers, or any combination thereof. In one embodiment, the fiber material is carbon fiber. In this embodiment, carbon fibers exhibit a length less than about 1 inch, for example less than about ½ inch. For example, the fiber material may include 3k tow weave carbon fiber chopped or otherwise cut to a length of less than about ¼ inch.

The density adjustment material may be an inert filler material. In some embodiments, the density adjustment material includes perlite. In some embodiments, the density adjustment material includes amorphous mineral silicate. For example, the density adjustment material may include Dicaperl™ HP900. In yet another example, the density adjustment material includes dry powders in bubble form that may be glass based. In another example, the density adjustment material includes dry powders in bubble form that may be silica based. The density adjustment material has a density between about 0.100 g/cc and about 0.200 g/cc, for example, about 0.112 g/cc. The density adjustment material includes an average particle diameter. For example, the average particle diameter of the density adjustment material is between about 1 micron and about 250 microns, such as between about 25 microns and about 100 microns, such as between about 50 microns and about 70 microns. In one embodiment, the average particle diameter of the density adjustment material is between about 60 microns and about 70 microns.

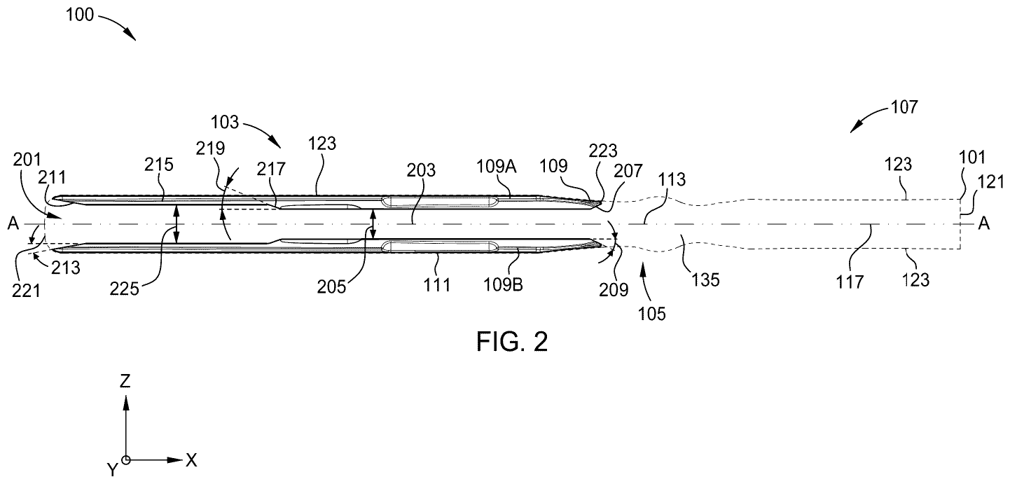

FIG. 2 illustrates a top view of the stock assembly 100, according to one or more embodiments. The shell 101 of the stock assembly 100 includes a frame cavity 201, a stock axis A, and a chassis region 203. The frame cavity 201 is a space defined within the shell 101. The frame cavity 201 is partially formed by a U-shape in front region 103. The frame cavity 201 is then partially enclosed within the shell 101 in the grip region 105 and rear region 107. The frame cavity 201 is surrounded by the shell 101 along the stock axis A such that the frame cavity 201 is a hollow orifice in the grip region 105 and rear region 107. The frame cavity 201 extends through the butt 121. The frame cavity 201 includes a chassis width 205 in the front region 103. The chassis width 205 along the Z-axis is between about 0.75 inches and about 1.5 inches. For example, the chassis region 203 has a chassis width 205 of about 1 inches. The chassis region 203 has a length along the X-axis between about 10 inches and about 12 inches. For example, the chassis region 203 has a length along the X-axis of about 11 inches.

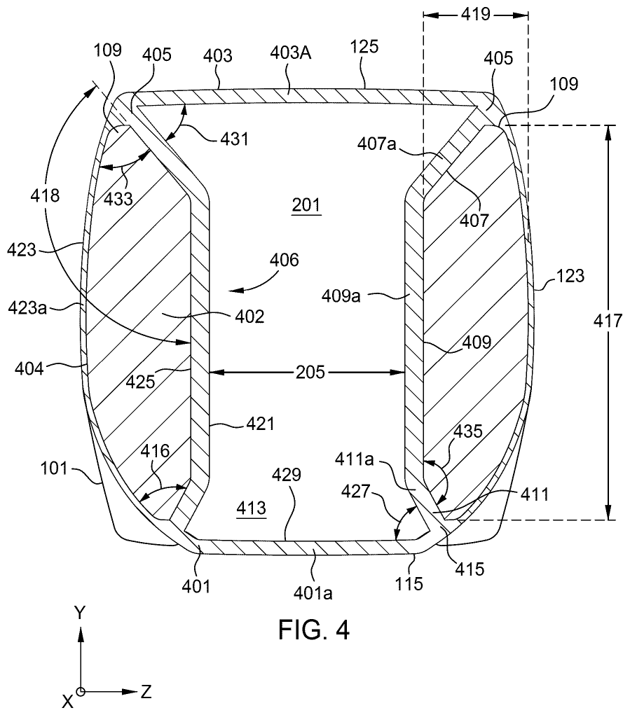

The chassis region 203 is disposed in the front region 103, between the stiffeners 109, and proximate to the grip region 105. A chassis, action, bottom metal, trigger group, and/or any combination thereof may be located in the chassis region 203. In some embodiments, the stiffeners 109 have a higher density in the chassis region 203 to increase the strength of the stock assembly 100. In one embodiment, the stiffener 109 includes a variable density along the X, Y, and Z-axes. Alternatively, stiffener density along the X, Y, and Z-axes may be substantially similar depending upon the desired strength characteristics of the stock assembly 100. The stiffeners 109 include a plurality of tapers 207, 211 and reductions 217. A grip taper 207 is disposed near the grip end 223 of the stiffeners 109. The grip taper 207 has a grip taper angle 209. The grip taper angle 209 is between about 1° and about 30°. For example, the grip taper angle 209 is about 15°. The grip taper 207 has a length along the stock axis A from the grip end 223 towards the muzzle end 221 of the stiffener 109 between about 0.5 inches and about 1.5 inches. For example, the grip taper 207 length is about 0.75 inches. The forend taper 211 is disposed proximate to the muzzle end 221 of the stiffener 109. The forend taper 211 has a forend taper angle 213. The forend taper angle 213 is between about 1° and about 30°. For example, the forend taper angle 213 is about 15°. The forend taper 211 has a length along the stock axis A of between about 0.5 inches and about 1.5 inches. For example, the forend taper 211 length is about 1 inches. The first reduction 217 is disposed at a stiffener reduction region 215. The stiffener reduction region 215 is disposed between the chassis region 203 and the stiffener muzzle end 221. The stiffener reduction region 215 includes a length along the X-axis between about 1 inch and about 5 inches, for example, about 3 inches. The frame cavity 201 also includes a second width 225 disposed at the stiffener reduction region 215. The second width 225 extends between a frame interior surface 421 (FIG. 4). The second width 225 is between about 0.5 inches and about 3 inches, for example, about 1.5 inches.

The first reduction 217 has a reduction angle 219. The reduction angle 219 is between about 1° and about 30°. For example, the reduction angle 219 is about 15°. The first reduction 217 has a length along the stock axis A from the stiffener grip end 223 towards the muzzle end 221 between about 0.25 inches and about 1.5 inches. For example, the first reduction 217 length is about 1 inch. The plurality of tapers 207, 211 and reductions 217 help to minimize weight and soften corner profiles. These tapers 207, 211 and reductions 217 enhance a molding process. The reduction of corners also helps create strong bonds between the shell 101 and the stiffener 109 and mitigates cavities and voids during a molding process. The reduction of corners also prevents or reduces the probability of delamination at hard edges of the shell 101 where the shell 101 is thin.

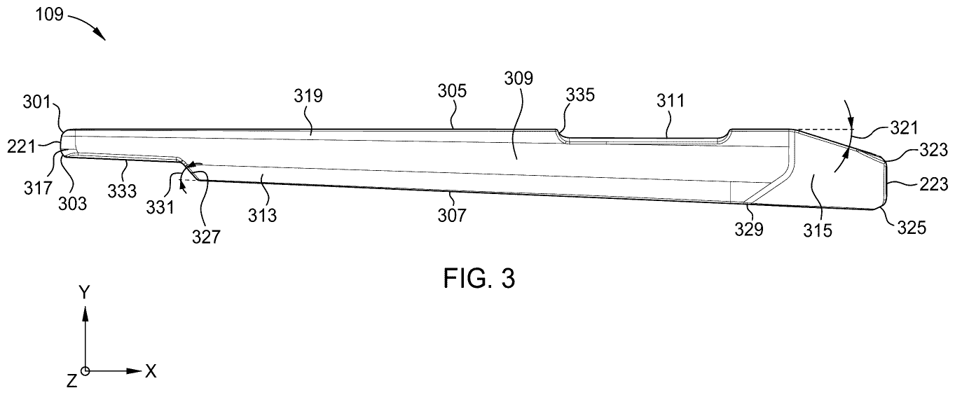

FIG. 3 illustrates a side view of the stiffener 109 according to some embodiments. The stiffener 109 further includes a front top corner 301, a front bottom corner 303, a stiffener top 305, a stiffener bottom 307, an ejection region 311, an accessory contour 327, a plurality of additional tapers 313, 315, 317, 319, a transition region 329, and a stiffener outward face 309. The front top corner 301 and the front bottom corner 303 are disposed on the muzzle end 221. The front top corner 301 includes a radius between about 0.1 inches and about 0.5 inches, for example, about 0.2 inches. The front bottom corner 303 includes a radius between about 0.1 inches and about 0.5 inches, for example, about 0.2 inches. A front taper 317 is disposed on the muzzle end 221. The front taper 317 curves from the outward face 309 to the muzzle end 221. The front taper 317 has a length along the X axis between about 0.25 inches and about 1.5 inches, for example, about 1 inch. The accessory contour 327 follows the accessory region 127 (FIG. 1). The accessory contour 327 angles an accessory contour angle 331 from the stiffener bottom 307 toward an accessory edge 333. The accessory contour 327 has a height along the Y axis between about 0.2 inches and about 0.5 inches, for example, about 0.4 inches. The angle 331 is between about 1° and about 30°, for example, about 15°. The accessory edge 333 is about parallel with the stiffener bottom 307 and has a length along the X axis between about 2.25 inches and about 4.5 inches, for example, about 3 inches. The stiffener bottom 307 has a length along the X axis between about 12 inches and about 15 inches, for example, about 13 inches. In some embodiments, the stiffener bottom 307 is angled between about 2° and about 4° from the stiffener top 305. For example, the stiffener bottom 307 is angled between about 2.5° from the stiffener top 305. The stiffener bottom 307 includes a lower taper 313. The lower taper 313 curves from the outward face 309 to stiffener bottom 307. The lower taper 313 has a height along the Y axis between about 0.25 inches and about 1.5 inches, for example, about 1 inch. The stiffener bottom 307 extends between the accessory contour 327 and the stiffener grip end 223. The stiffener bottom 307 extends between about 13 inches and about 16 inches, for example, about 15.3 inches. The stiffener top 305 extends between the muzzle end 221 stiffener grip end 223. The stiffener top 305 and has a length along the X axis between about 17 inches and about 20 inches, for example, about 18 inches. The stiffener top 305 includes the top taper 319 and the ejection region 311. The ejection region 311 is a section of the stiffener top 305 that is recessed toward the stiffener bottom 307, in the negative Y direction. The ejection region 311 is recessed a distance from stiffener top 305 between about 0.25 inches and about 1 inch, for example, about 0.5 inches. The ejection region 311 includes a width and an ejection fillet 335. The ejection fillet 335 is a fillet from the outward face 309 and the top taper 319 to the ejection region 311. The width of the ejection region 311 is along the X axis and is between about 2.25 inches and about 5.5 inches, for example, about 4 inches. The top taper 319 is a taper curving from the outward face 309 towards the stiffener top 305. The top taper 319 has a length along the Y axis between about 0.25 inches and about 1 inch, for example, about 0.5 inches. The transition region 329 is a face between rear taper 315 and outward face 309, the top taper 319 and the lower taper 313. The rear taper 315 slopes away from the transition region 329 toward the grip end 223 in the negative Z direction as shown. The rear taper 315 includes the grip top corner 323 and the grip bottom corner 325. The grip top corner 323 and the grip bottom corner 325 each include a radius. The radius of the grip top corner 323 is between about 01 inches and about 0.5 inches, for example, about 0.3 inches. The radius of the grip bottom corner 325 is between about 01 inches and about 0.5 inches, for example, about 0.3 inches. The grip top corner 323 is below and angled down from the top 305 at a top grip taper angle 321. The top grip taper angle 321 is between about 5° and about 45° for example, about 30°.

FIG. 4 illustrates a cross section of the stock assembly 100 of FIG. 1 at section A-A according to some embodiments. The shell 101 further includes a forend layer 401, one or more stiffener cavities 402, a top layer 403, a plurality of internal members 406, a frame interior surface 421, and a dovetail region 413. The forend layer 401 forms the forend 115. The forend layer 401 includes a thickness 401a, a lower cavity face 429, and a width along the Z axis that varies along the stock axis A (FIG. 1). The width of the forend layer 401 is between lower buildup regions 415. The width of the forend layer 401 is between about 1.25 inches and about 3.5 inches, for example, about 1.75 inches. The thickness 401a is along the Y axis and is between the lower cavity face 429 and the forend 115. The forend layer thickness 401a is between about 0.01 inches and about 0.5 inches, for example, about 0.125 inches.

The plurality of internal members 406 includes one or more top stiffener members 407, middle stiffener members 409, and lower stiffener members 411. In some embodiments two lower stiffener members 411 are coupled to the forend layer 401 and form a forend-to-stiffener angle 427 and a lower cavity angle 435. The forend-to-stiffener angle 427 is between about 45° and about 85°, for example, about 70°. The lower cavity angle 435 is formed between the lower stiffener members 411 and the middle stiffener member 409. The lower angle 435 is between about 100° and about 170°, for example, about 135°. The lower stiffener members 411 have a length and a thickness 411a. The lower stiffener member thickness 411a is between about 0.01 inches and about 0.5 inches, for example, about 0.125 inches. The lower stiffener members' 411 length is between about 0.25 inches and about 1 inch, for example, about 0.5 inches. Two middle stiffener members 409 are each disposed between and coupled to a respective lower stiffener member 411 and respective top stiffener members 407. Each of the two middle stiffener members 409 include a stiffener face 425, the frame interior surface 421, a thickness 409a along the Z axis, and a height along the Y axis. The middle stiffener members 409 are spaced the chassis width 205 apart. The thickness 409a is between about 0.01 inches and about 0.5 inches, for example, about 0.125 inches. The height of the middle stiffener members 409 along the Y axis between about 0.5 inches and about 1.5 inches, for example, about 1.2 inches. Two top stiffener members 407 are disposed between and coupled to a respective buildup region 405 and a respective middle stiffener member 409. The top stiffener members 407 include a thickness 407a, a length, a lower angle 435, and an upper angle 418. The top stiffener members 407 angle from their respective middle stiffener members 409 toward the buildup regions 405 on the lateral face 123. The length of the top stiffener members 407 is between about 0.25 inches and about 1 inch, for example, about 0.6 inches. The thickness 407a of the top stiffener members 407 is between about 0.01 inches and about 0.5 inches, for example, about 0.125 inches. The upper angle 418 is formed between middle stiffener members 409 and the top stiffener member 407. The upper angle 418 is between about 100° and about 170°, for example, about 135°. The lower angle 435 is formed between middle stiffener members 409 and the lower stiffener member 411. The lower angle 435 is between about 100° and about 170°, for example, about 135°.

As illustrated, the top 125 includes a top layer 403. The top layer 403 is formed during a manufacturing process but is eventually removed. This is discussed in more detail below. The top layer 403 is disposed between the two buildup regions 405. The top layer 403 includes a thickness 403a along the Y axis. The thickness 403a is between about 0.01 inches and about 0.5 inches, for example, about 0.125 inches. The one or more stiffener cavities 402 are disposed within the shell 101. The one or more stiffener cavities 402 are defined by a stiffener cavity internal surface 404. The stiffener cavity internal surface 404 is adjacent to the lateral face 123, the top stiffener members 407, the middle stiffener members 409, the lower stiffener members 411, the lower buildup regions, and the upper buildup regions 405. The one or more stiffener cavities 402 are configured to hold the stiffeners 109. The lateral face 123 has a lateral face thickness 423. The lateral face thickness 423a is defined by stiffener cavity internal surface 404 and the lateral face 123. The lateral face thickness 423 is between about 0.01 inches and about 0.2 inches, for example, about 0.06 inches.

The frame cavity 201 is partially defined by the frame interior surface 421 and the lower cavity face 429. The frame cavity 201 includes the dovetail region 413. The dovetail region 413 is defined by the middle stiffener members 409, the lower stiffener members 411, and the lower cavity face 429. The dovetail region 413 forms a trapezoidal shape because the distance between the lower buildup regions 415 is larger than the chassis width 205. The distance between the lower buildup regions 415 is between about 0.5 inches and about 1.5 inches, for example, about 1 inch. The distance between the upper buildup regions 405 is between about 0.5 inches and about 1.5 inches, for example, about 1 inch. The stiffeners 109 further include a stiffener height 417 and stiffener depth 419. The stiffener height 417 and stiffener depth 419 vary along the stock axis A. At cross section A-A the stiffener height 417 along the Y axis is between about 1 inch and about 2 inches, for example, about 1.7 inches. At cross section A-A the stiffener depth 419 along the Z axis is between about 0.3 inches and about 0.7 inches, for example, about 0.425 inches. The buildup regions 405, 415 are configured to give added support to the shell 101 and added protection to the stiffeners. The buildup regions 405, 415 are thicker to prevent delamination. The buildup regions 405, 415 have a minimum thickness between about 01 inches to about 0.3 inches, for example, about 0.2 inches. The upper buildup regions 405, 415 further enable a more efficient manufacturing process. The manufacturing process is discussed in more detail below. The upper build up region 405 includes an upper buildup angle 431 and an upper stiffener angle 433. The upper buildup angle 431 is formed between the top stiffener member 407 and the top layer 403. The upper buildup angle 431 is between about 20° and about 70°, for example, about 45°. The upper stiffener angle 433 is formed between the top stiffener member 407 and stiffener cavity internal surface 404. The upper stiffener angle 433 is between about 20° and about 70°, for example, about 45°. The lower buildup regions 415 include the forend-to-stiffener angle 427 and the lower stiffener angle 416. The lower stiffener angle 416 is formed between the lower stiffener member 411 and stiffener cavity internal surface 404. The lower stiffener angle 416 is between about 10° and about 70°, for example, about 30°.

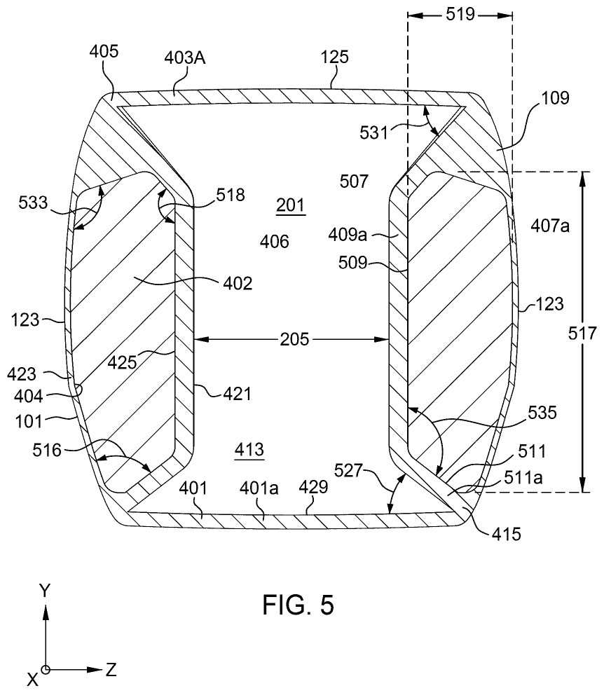

FIG. 5 illustrates a cross section of the stock assembly 100 of FIG. 1 at section B-B according to some embodiments. The shell 101 of FIG. 5 is similar to the shell 101 of FIG. 4. Differences may include a different stiffener height 517, stiffener depth 519, the lengths of the top, middle, and lower members, the lower angle 516, upper angle 518, forend-to-stiffener angle 527, upper buildup angle 531, upper stiffener angle 533, and lower cavity angle 535. At cross section B-B the stiffener height 517 along the Y axis is between about 0.75 inches and about 1.5 inches, for example, about 1.3 inches. At cross section B-B the stiffener depth 519 along the Z axis is between about 0.3 inches and about 0.7 inches, for example, about 0.45 inches. The lower angle 516 is between about 30° and about 80°, for example, about 60°. The upper angle 518 is between about 100° and about 160°, for example, about 135°. The forend-to-stiffener angle 527 is between about 20° and about 70°, for example, about 60°. The upper buildup angle 531 is about 20° and about 70°, for example, about 60°. The upper stiffener angle 533 is between about 20° and about 70°, for example, about 60°. The lower cavity angle 535 is between about 100° and about 160°, for example, about 135°. The middle stiffener members 509 at cross section B-B are still spaced the chassis width 205 apart. The length of the lower member 511 is between about 0.5 inches and about 1.5 inches, for example, about 0.75 inches. The length of the middle member 509 is between about 0.5 inches and about 2 inches, for example, about 1 inch. The length of the top member 507 is between about 0.75 inches and about 2 inches, for example, about 1.3 inches.

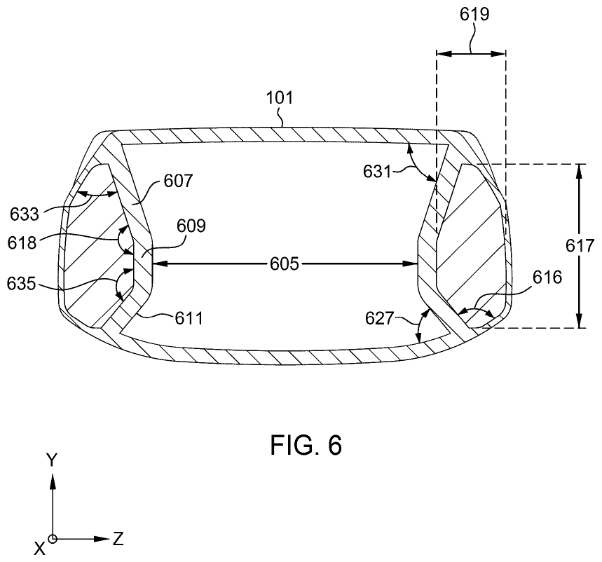

FIG. 6 illustrates a cross section of the stock assembly 100 of FIG. 1 at section C-C according to some embodiments. The shell 101 of FIG. 6 is similar to the shell 101 of FIGS. 4 and 5. Differences may include a different stiffener height 617, stiffener depth 619, the lengths of a top member 607, a middle member 609, and a lower member 611, the lower angle 616, upper angle 618, forend-to-stiffener angle 627, upper buildup angle 631, upper stiffener angle 633, and lower cavity angle 635. At cross section C-C the stiffener height 617 along the Y axis is between about 0.5 inches and about 1 inch, for example, about 0.67 inches. At cross section C-C the stiffener depth 619 along the Z axis is between about 01 inches and about 0.4 inches, for example, about 0.275 inches. The lower angle 616 is between about 30° and about 80°, for example, about 60°. The upper angle 618 is between about 100° and about 160°, for example, about 135°. The forend-to-stiffener angle 627 is between about 20° and about 70°, for example, about 60°. The upper buildup angle 631 is about 20° and about 70°, for example, about 60°. The upper stiffener angle 633 is between about 20° and about 70°, for example, about 60°. The lower cavity angle 535 is between about 100° and about 160°, for example, about 135°. The length of the lower member 611 is between about 0.25 inches and about 1.25 inches, for example, about 0.5 inches. The length of the middle member 609 is between about 01 inches and about 1 inch, for example, about 0.5 inches. The length of the top member 607 is between about 0.5 inches and about 1.5 inches, for example, about 0.75 inches. The middle stiffener members 609 at cross section C-C are spaced a second width 605 apart. The second width 605 is between about 0.25 inches and about 1.75 inches, for example, about 1.13 inches.

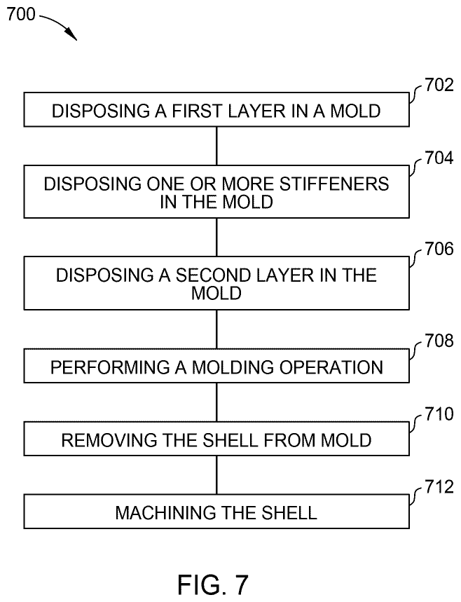

FIG. 7 illustrates a process flow of forming the stock assembly 100 according to some embodiments. The process 700 begins with a disposing a first layer at operation 702. Operation 702 includes applying a mold release agent to a mold. Once the agent is applied, a first layer of shell material is disposed into a mold. The shell material may be the same shell material described above. The first layer of shell material may be disposed in recesses within the mold and then trimmed such that no edges stick out from a surface of the mold. The mold has the recesses configured to hold one or more stiffeners 109. Once placed into the mold, the first layer is pressed against the recess surface of the mold. The pressing can be done by hand and/or by machine. Other pressing methods are contemplated. The pressing is done such that the first layer of shell material is in contact with about all of the mold recess surface. In some embodiments the first layer is trimmed at a later operation.

Once the first layer is disposed, stiffener disposing operation 704 is performed. Stiffener disposing includes disposing one or more stiffeners 109 into the mold adjacent to the first layer of shell material. The mold may include recesses that are configured to minimize gaps between the first layer of shell material, the one or more stiffeners 109, and the surface of the mold. The mold recesses may be configured to include specific recesses such that the first layer of shell material and the one or more stiffeners 109 conform to each other during a baking and/or curing operation. The stiffeners may be pre-cured up to a temperature between about 100° C. to about 150° C., for example about 120° C., before being placed into the mold.

Once the one or more stiffeners 109 are disposed, a second layer disposing operation 706 is performed. Disposing a second layer includes disposing a second layer of shell material into the mold. In some embodiments, the disposing a second layer includes disposing a second layer on the stiffeners and the first layer of shell material. In other embodiments disposing a second layer includes disposing a second layer of shell material into a second mold. The second mold is configured to be connected to a first mold having the first layer of shell material and the one or more stiffeners. Once the second layer of shell material is disposed in the mold, the second layer is pressed into the mold recess with a pressing tool. The pressing can be done by a tool configured to smooth out the second layer against the mold recess, the one or more stiffeners, and the first layer of shell material. The pressing is done such that the second layer of shell material is in contact with about most of the mold, the one or more stiffeners, and the first layer of shell material. In some embodiments a bladder is inserted into the mold before the second layer of shell material is applied. In other embodiments a bladder is applied to the mold after the second layer of shell material is applied. The mold is then secured by applying a mold cap. In some embodiments the mold cap is the second mold. In other embodiments, the mold cap is another member with recesses configured to apply heat and pressure to the mold.

At a molding operation 708, the mold and mold cap are coupled to a molding machine. In some embodiments the molding operation is a bladder molding operation. Other molding operation embodiments include compression molding, press molding, and modified closed molding, but other molding operations are contemplated. For example, the molding operation may include a baking operation where a bladder is not required. The molding machine may be a bladder molding machine according to some embodiments. The molding machine applies heat to the mold, heating the mold, the first layer of shell material, the second layer of shell material, and the one or more stiffeners. The heat is applied during a cure time. The cure time is between about 0.5 hours and about 4 hours for example, about 2 hours. During the cure time the first layer of shell material, the second layer of shell material, and the one or more stiffeners reach a temperature between about 150° F. and about 400° F., for example, about 315° F. Specifically, the cure time includes a heat up time where the molding machine reaches a temperature of about 230° F. to about 250° F. in about 30 minutes. During the cure time, after the 30 minutes of heat up time, the resin begins to cure for about 1.5 hours such that the mold, the first layer of shell material, the second layer of shell material, and the one or more stiffeners cure at a temperature between about 250° F. to about 315° F. such that the stock assembly is cured when in reaches 315° F. with a total time in the molding machine being less than 3 hours. During the cure time the molding machine may inflate the bladder. The bladder applies a pressure between about 80 psi and about 450 psi, for example, about 200 psi.

The heat and pressure cause the first layer of shell material, the second layer of shell material, and the one or more stiffeners to co-cure. This co-cure enables bonds to be formed such that a bond forms between each of the first layer of shell material, the second layer of shell material, and the one or more stiffeners. The bonds form because the first layer of shell material, the second layer of shell material, and the one or more stiffeners share a common chemical attribute. For example, the chemical attribute may be a common resin. In some embodiments, the resin may be an epoxy resin, but other bonding agents are contemplated. For example, the common chemical attribute may be that the resin matrix of the shell 101 and resin matrix of the stiffener 109 are both epoxy resin. In yet another example, the common chemical attribute may be that the resin matrix of the shell 101 and resin matrix of the stiffener 109 are both polyurethane resin, but other common chemical attributes are contemplated. For example, the common chemical attribute may be that the resin matrix of the shell 101 and resin matrix of the stiffener 109 are both polyester resins, polyethylene resins, vinyl ester resins, polyimide resins, or any combination thereof. When the co-cure happens the bonds form a much stronger structure than another shell that does not share a common chemical attribute. These bonds that occur from the co-cure add at least strength, rigidity, delamination resistance to the shell 101. These bonds create a shell 101 that also better resists internal separation.

Once the shell has been formed and cooled and the mold has cooled, the shell 101 is removed during a removal operation 710. The removal operation 710 includes removing the shell 101 from the mold. The removal operation 710 may also include an inspection to ensure uniformity was achieved. The removal operation 710 may also include trimming excess first layer and/or second layer of shell material from any seams.

Once the shell has been removed, the shell goes through a machining operation 712. The machining operation includes partial removal of excess material. The excess material may include the top layer 403. The shell 101 is machined to partially remove the top layer 403 but leave the upper buildup regions 405 intact. This allows a thickness at the buildup region 405 from the top of the stiffener 109 to the top 125 of the shell 101. The thickness at the buildup region 405 is between about 0.12 inches and about 0.5 inches, for example, about 0.25 inches. The buildup region 405 enables stronger resistance to delamination and better durability. The machining may be done at least by hand, by a milling machine, and/or by an automated material removal device. The combination of a bladder molding process enables minimal post mold machining. In total, the process enables a much more efficient shell forming process such that a shell can be formed from the layers and stiffeners and ready for internal parts assembly in less than 4 hours, for example in less than 3 hours.

The above described embodiments yield a surprising new strength to weight ratio. The stock was tested using a modified bend test similar to ASTM E290 and ISO 178 standards for 3 point failure testing.

In some embodiments, the stock assembly weighed between about 26 oz. to about 34 oz., wherein the core material of the one or more stiffeners accounted for between about 7 oz. to about 10 oz. and the stock assembly included an ultimate failure load greater than about 550 lbs.

In a first embodiment, the stock assembly weighed between about 26.5 oz. to about 27.5 oz. wherein the core material of the one or more stiffeners accounted for between about 7 oz. to about 8 oz. and the stock assembly included an ultimate failure load between about 540 lb and about 565 lb.

In a second embodiment, the stock assembly weighed between about 27 oz. to about 29 oz, wherein the core material of the one or more stiffeners accounted for between about 8 oz. to about 9 oz. and the stock assembly included an ultimate failure load between about 635 lb. and about 645 lb.

In a third embodiment, the stock assembly weighed between about 30 oz. to about 31 oz, wherein the core material of the one or more stiffeners accounted for between about 7 oz. to about 8 oz. and the stock assembly included an ultimate failure load between about 640 lb. and about 650 lb.

During testing various embodiments of the stock assembly showed surprisingly better performance by increasing rigidity, resisting delamination, and improving overall strength from prior designs. The improvements described above enabled the stock assembly to have a pound force at ultimate failure per ounce of weight (lb./oz.) of between about 19 lb./oz. and about 23 lb./oz. For example, between about 22.5 lb./oz. and about 20 lb./oz. In yet another example, about 21 lb./oz. In some embodiments the deflection before ultimate failure was less than about 0.027 in. For example, when a force of about 640 lbs. was applied to the stock assembly in a 3 point bend test, the stock assembly deflected less than or equal to about 0.025 in.

The above examples are not limiting in scope and are provided to further illustrate possible applications and embodiments.

While the foregoing is directed to embodiments of the present disclosure, other and further embodiments of the disclosure may be devised without departing from the basic scope thereof, and the scope thereof is determined by the claims that follow.

What is claimed is:

1. A stock assembly, comprising:
a shell, the shell comprising:
a front region;
a grip region disposed between the front region and a rear region;
a frame cavity extending through the front region, grip region, and rear region, partially defined by the shell; and
one or more stiffener cavities disposed within the front region of the shell; and
one or more stiffeners disposed within the one or more stiffener cavities, the one or more stiffeners comprising a core material bonded to an internal surface of the one or more stiffener cavities.

2. The stock assembly of claim 1, wherein the core material comprises:
a first resin;
a second resin;
a density adjustment material; and
a fiber material.

3. The stock assembly of claim 2, wherein the first resin and the second resin are epoxy resins.

4. The stock assembly of claim 2, wherein the fiber material comprises a plurality of fibers, each fiber of the plurality of fibers having a length less than about ½ inch.

5. The stock assembly of claim 4, wherein the fiber material is carbon fiber.

6. The stock assembly of claim 1, wherein the stiffeners comprise a variable density.

7. The stock assembly of claim 1, wherein the front region comprises a forend layer.

8. The stock assembly of claim 1, further comprising a thumb shelf, the stiffeners at least partially disposed in an overlapping relationship with the thumb shelf.

9. The stock assembly of claim 1, wherein the shell comprises a shell resin configured to bond to the core material.

10. A stock stiffener, comprising:
a muzzle end and a grip end;
a plurality of tapers; and
a core material, the core material comprising:
a first resin;
a second resin;
a first material; and
a fiber material.

11. The stock stiffener of claim 10, wherein the core material further comprises percentages of the first resin, the second resin, the first material, and fiber material, such that the core material has a weight % of the fiber material between about 10% and about 11.5% of core material.

12. The stock stiffener of claim 10, wherein the first resin and the second resin are epoxy resins configured to form a bond with a stock.

13. The stock stiffener of claim 10, wherein the stiffener has a density between about 0.7 g/cc to about 0.8 g/cc, and the stock has an ultimate failure load between about 550 lbs. to about 650 lbs.

14. The stock stiffener of claim 10, wherein the fiber material comprises a plurality of fibers, each fiber of the plurality of fibers having a length less than about ½ inch.

15. The stock stiffener of claim 14, wherein the fiber material comprises carbon fiber.

16. The stock stiffener of claim 10, wherein the plurality of tapers are configured to enhance a molding process.

17. A process of forming a stock, comprising:
disposing a first layer of a shell material in a mold;
disposing one or more stiffeners on the first layer within the mold;
disposing a second layer of the shell material over the one or more stiffeners and the first layer;
co-curing the first layer, the one or more stiffeners, and the second layer, such that a bond forms between the one or more stiffeners, and the shell material; and
forming the shell.

18. The process of claim 17, wherein each of the one or more stiffeners comprises a plurality of tapers configured to minimize voids.

19. The process of claim 17, wherein the one or more stiffeners comprise:
a first resin;
a second resin;
a first material; and
a fiber material.

20. The process of claim 17, wherein forming the shell comprises forming a frame cavity partially defined by the shell.

21. The process of claim 17, wherein forming the shell comprises using a bladder molding process.

22. The process of claim 17, wherein co-curing the first layer, the one or more stiffeners, and the second layer comprises a cure time that is less than about 3 hours at a temperature between about 250° F. to about 350° F.

23. The process of claim 17, further comprising removing excess material such that an upper buildup region is disposed in the stock.
